(19) United States
(12) Patent Application Publication
(10) Pub. No.: US 2009/0171663 A1
(43) Pub. Date: Jul. 2, 2009

(54) REDUCING A SIZE OF A COMPILED SPEECH RECOGNITION GRAMMAR

(75) Inventors: DANIEL E. BADT, ATLANTIS, FL (US); VLADIMIR BERGL, PRAHA (CZ); JOHN W. ECKHART, BOCA RATON, FL (US); RADEK HAMPL, PRAHA (CZ); JONATHAN PALGON, BOYNTON BEACH, FL (US); HARVEY M. RUBACK, LOXAHATCHEE, FL (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/968,248

(22) Filed: Jan. 2, 2008

(51) Int. Cl. G10L 15/06

(52) U.S. Cl. 704/257; 704/E15.007

(57) ABSTRACT

The present invention discloses creating and using speech recognition grammars of reduced size. The reduced speech recognition grammars can include a set of entries, each entry having a unique identifier and a phonetic representation that is used when matching speech input against the entries. Each entry can lack a textual spelling corresponding to the phonetic representation. The reduced speech recognition grammar can be digitally encoded and stored in a computer readable media, such as a hard drive or flash memory of a portable speech enabled device.

### BACKGROUND

1. Field of the Invention

The present invention relates to the field of speech processing technologies and, more particularly, to reducing a size of a compiled speech recognition grammar.

2. Description of the Related Art

Speech input modalities are an extremely convenient and intuitive mechanism for interacting with computing devices in a hands free manner. Speech input modalities can be especially advantageous for interactions involving portable or embedded devices, which lack traditional input mechanisms, such as a full sized keyboard and/or a large display screen. At present, small devices often offer a scrollable selection mechanism, such as an ability to view all entries and highlight a particular selection of interest. As a number of items on a device increase, however, scroll based selections become increasingly cumbersome. Speech based selections, on the other hand, can theoretically handle selections from an extremely long list of items with ease.

Speech enabled systems match speech input against a set of phonetic representations contained in a speech recognition grammar. Each recognition grammar entry typically contains a unique identifier (i.e., primary key for database and programmatic identification purposes), the phonetic representation, and a textual representation. Multiple recognition grammars can exist on a single device, such as multiple context dependent grammars and/or multiple speaker dependent grammars. An amount of storage space required for containing all device needed recognition grammars can be relatively large when significant numbers of speech recognizable entries exist for a device.

For example, a speech enabled navigation system can include a large database of street names to be recognized, which each have corresponding speech recognition grammar entries. In another example, digital media players can include hundreds or thousands of songs, which are each multiply indexed based on artist, album, and song title, each user selectable indexing mechanism requiring a corresponding recognition grammar.

Portable devices are typically resource constrained devices, which can lack vast reserves of available storage space. What is needed is a technique to reduce the amount of memory consumed by recognition grammar entries without reducing the scope of the set of items contained in the recognition grammars. Many traditional storage conservation techniques, such as compressing files, are not helpful in this context due to corresponding performance and processing detriments associated with implementing compression/decompression techniques. Any solution designed for conserving memory of resource constrained devices should ideally not cause performance to suffer, since additional processing resources are often as scarce as memory resources and since increased latencies can greatly diminish a user's satisfaction with the device and the feasibility of the solution.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a flow chart of a method for reducing a size of a compiled speech recognition grammar by excluding a textual representation of an associated phrase from the grammar.

FIG. 2 is a schematic diagram showing a speech enabled device that uses a grammar compiler to minimize a size of recognition grammars in accordance with an embodiment of the inventive arrangements disclosed herein.

### DETAILED DESCRIPTION OF THE INVENTION

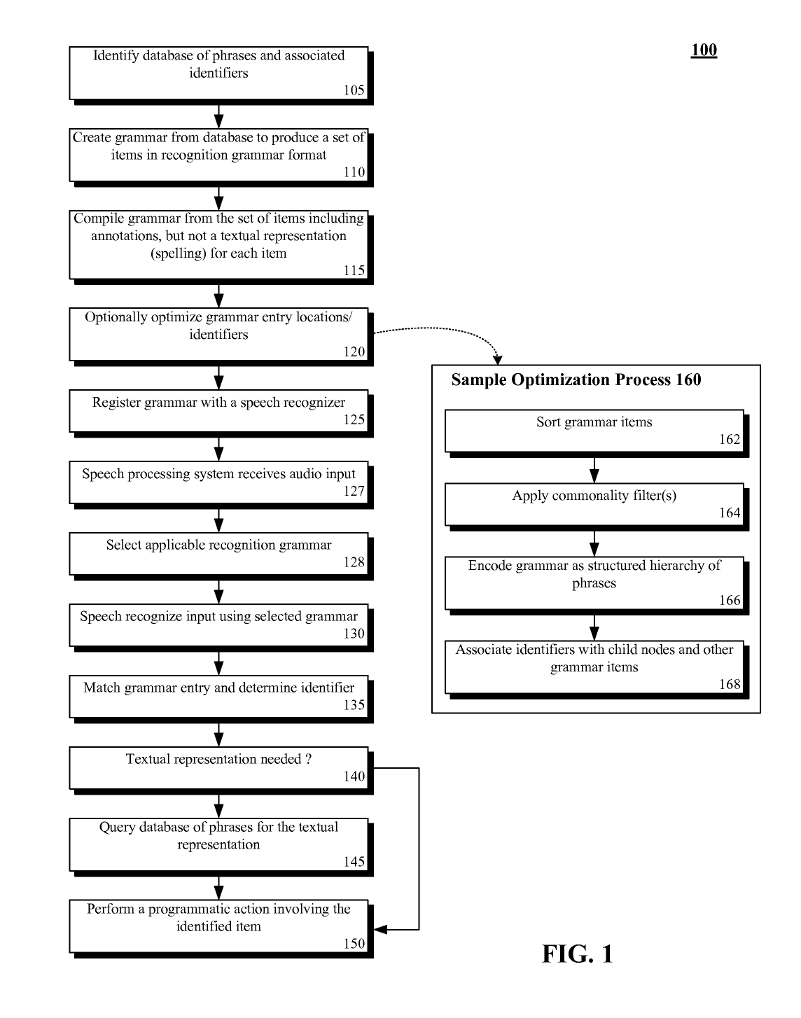

FIG. 1 is a flow chart of a method 100 for reducing a size of a compiled speech recognition grammar by excluding a textual representation of an associated phrase from the grammar. Speech grammar entries presently include a unique entry identifier, a phonetic representation that is matched against received speech, and a textual phase for the unique identifier. In many instances, the textual phrase is actually not needed. For example, when responding to a speech phrase “call Mr. Smith,” a speech enabled mobile phone needs to translate the speech into an action (which uses the entry identifier that is matched to a phonetic representation that matches the speech input). The textual phrase for the recognition result contained in the recognition grammar is not necessarily used. Additionally, a different data store of the device can associate the textual phrases with the unique identifiers, which makes the textual representation in the speech recognition grammars largely redundant. Furthermore, only one entry is sufficient in a data store as opposed to multiple entries for the same unique identifier in several recognition grammars differing by assumed speech context.

The present invention removes that redundancy, which can result in significant memory savings for recognition grammars. For example, memory requirements for storing the textual representation is often approximately equivalent to memory requirements for the phonetic representation, both of which are substantially larger than memory requirements for the unique identifier. Thus, removing textual entries from speech recognition grammars can result in approximately a forty to fifty percent reduction in memory consumption related to the recognition grammars.

As shown, method 100 can begin in step 105, where a database of phrases and associated identifiers can be identified. One or more speech recognition grammar can correspond to this data store. In one embodiment, the related recognition grammars can be created from the speech recognition data store, as shown in step 110. In another embodiment, the related speech recognition grammars can be externally created and/or provided for use by a speech-enabled device along with the entries of the data store. For example, the recognition grammar can be configured at a factory and installed within a speech enabled device. The grammar format for the recognition grammar can conform to any of a variety of standards and can be written in a variety of grammar specification languages.

In step 115, the recognition grammar can be compiled to include annotations (unique entry identifiers) and phonetic representations but to exclude text representations. In optional step 120, the grammar can be optimized by positioning annotation locations relative to phonetic representations in a manner that improves performance over non-optimized arrangements. Process 160 breakout shows one contemplated manner for optimizing the grammar. Other optimizations are possible and are to be considered within the scope of the invention.

In process 160, the grammar entries can be sorted. In step 164, commonality filters can be applied so that key phonetic similarities contained within entries are identified. In step 166, the filtered grammar can be digitally encoded as a structured hierarchy of phonetic representations for recognizable phrases. Parent nodes of the hierarchy can represent common phrase portions, where child nodes can represent unique portions sharing a commonality defined by the shared parent, where the commonalty is that detected by the commonality filter in step 164. The recognition grammar can be intended to recognize an input by the lowest level match in the structured hierarchy. In step 168, each terminal node, as well as selective intermediate nodes having a recognition meaning, can be associated with a unique identifier.

To illustrate this hierarchical structure, a speech enabled device can include a system command of “stop” that pauses music playback and can include speech selectable songs titled “Can't stop the feeling” and “Stop in the name of love.” The phonetic commonality of these three entries is a phrase portion for “stop.” Stop can be a parent node in the hierarchy, which is associated with a unique identifier for the stop system command. Child nodes can exist from the parent node for the songs “Can't stop the feeling” and “Stop in the name of love.” Each child can be associated with a unique identifier for the related song. An actual textual representation for the songs and system command will not be stored in the compiled grammar to conserve space.

Regardless of whether optimization occurs in step 120 or not, the compiled grammar can then be registered for use with a speech enabled device, as shown by step 125. Once registered, the speech enabled device can receive audio input, as shown by step 127. In optional step 128, an applicable recognition grammar can be selected. For example, a speaker dependent grammar associated with a user of the speech enabled device can be selected. In another example, a context dependent grammar applicable for the current context of the speech enabled device can be selected. Step 128 is optional since the method 100 can be performed in a speech-enabled environment that uses a speaker independent and context independent recognition grammar.

In step 130, the audio input can be processed by a speech recognition engine and compared against entries in the selected recognition grammar. In step 135, a grammar entry can be matched against the input phrase, which results in a unique phrase identifier being determined. In step 140, a determination can be made as to whether a textual representation for the phrase identifier is needed. If so, the database of phrases can be queried for this representation, as noted by step 145. In step 150, a programmatic action can be performed that involves the identified phrase and/or the textual representation optionally retrieved in step 145.

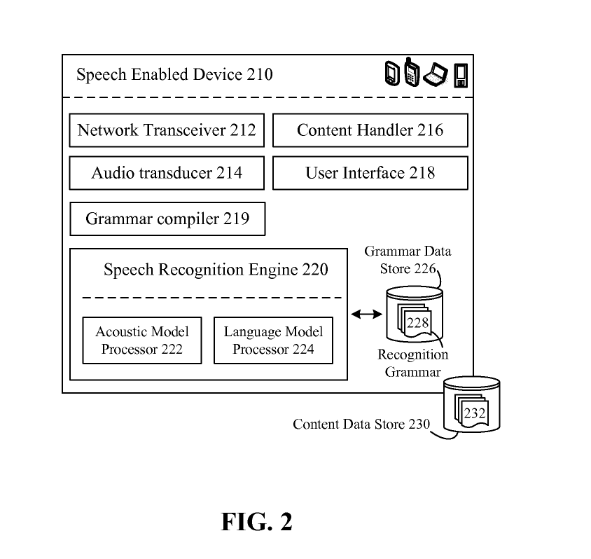

FIG. 2 is a schematic diagram showing a speech enabled device 210 that uses a grammar compiler to minimize a size of recognition grammars 228 in accordance with an embodiment of the inventive arrangements disclosed herein. The method 100 of FIG. 1 can be implemented by the device 210. Other implementations of the method 100 are contemplated, however, and the method 100 is not be construed as limited to components expressed in FIG. 2.

In FIG. 2, a speech enabled device 210 can generate recognition grammar 228 placed in data store 226 from items in a content data store 230. The items 230 can be textually specified items having a unique identifier. This unique identifier is stored along with a speech recognition data for the item in data store 226. The text specification for the item is not redundantly stored in the data store 226, as is standard practice. After placing the speech recognition data in the data store 226, user speech received through audio transducer 214 can be recognized by a speech recognition engine 220. Results from engine 220 can cause a programmatic action related to the item to be performed.

The speech enabled device 210 can optionally acquire new content to be placed in the data store 230 from a remotely located content source, which exchanges data over a network that device 210 connects to using the network transceiver 212. New content can be processed by grammar compiler 219, which creates entries for the new content that are placed in an appropriate grammar 228 of data store 226. A minimized recognition grammar 228 can also be established without using compiler 219, which occurs when a grammar 228 contains only factory established items. The grammar compiler 219 can be software capable of generating speech recognition data for textual items in a format compatible with a recognition grammar 228.

The speech recognition data can include phonetic representations of content items, which can be added to a speech recognition grammar 228 of device 210. The speech recognition data can conform to a variety of grammar specification standards, such as the Speech Recognition Grammar Specification (SRGS), Extensible MultiModal Annotation Markup (EMMA), Natural Language Semantics Markup Language (NLSML), Semantic Interpretation for Speech Recognition (SISR), the Media Resource Control Protocol Version 2 (MRCPv2), a NUANCE Grammar Specification Language (GSL), a JAVA Speech Grammar Format (JSGF) compliant language, and the like. Additionally, the speech recognition data can be in any format, such as an Augmented Backus-Naur Form (BNF) format, an Extensible Markup Language (XML) format, and the like.

The speech enabled device 210 can be any computing device able to accept speech input and to perform programmatic actions in response to the received speech input. The device 210 can, for example, include a speech enabled mobile phone, a personal data assistant, an electronic gaming device, an embedded consumer device, a navigation device, a kiosk, a personal computer, and the like.

The network transceiver 212 can be a transceiver able to convey digitally encoded content with remotely located computing devices. The transceiver 212 can be a wide area network (WAN) transceiver or can be a personal area network (PAN) transceiver, either of which can be configured to communicate over a line based or a wireless connection. For example, the network transceiver 212 can be a network card, which permits device 210 to connect to a content source over the Internet. In another example, the network transceiver 212 can be a BLUETOOTH, wireless USB, or other point-to-point transceiver, which permits device 210 to directly exchange content with a proximately located content source having a compatible transceiving capability.

The audio transducer 214 can include a microphone for receiving speech input as well as one or more speakers for producing speech output.

The content handler 216 can include a set of hardware/software/firmware for performing actions involving content 232 stored in data store 230. For example, in an implementation where the device 210 is an MP3 player, the content handler 216 can include codecs for reading the MP3 format, audio playback engines, and the like.

Device 210 can include a user interface 218 having a set of controls, I/O peripherals, and programmatic instructions, which enable a user to interact with device 210. Interface 218 can, for example, include a set of playback buttons for controlling music playback (as well as a speech interface) in a digital music playing embodiment of device 210. In one embodiment, the interface 218 can be a multimodal interface permitting multiple different modalities for user interactions, which include a speech modality.

The speech recognition engine 220 can include machine readable instructions for performing speech-to-text conversions. The speech recognition engine 220 can include an acoustic model processor 222 and/or a language model processor 224, both of which can vary in complexity from rudimentary to highly complex depending upon implementation specifics and device 210 capabilities. The speech recognition engine 220 can utilize a set of one or more grammars 228. In one embodiment, the data store 226 can include a plurality of grammars 228, which are selectively activated depending upon a device 210 state. Accordingly, grammar 228 to which the speech recognition data 226 is added can be a context dependent grammar, a context independent grammar, a speaker dependent grammar, and a speaker independent grammar depending upon implementation specifics for system 200.

Each of the data stores 226, 230 can be physically implemented within any type of hardware including, but not limited to, a magnetic disk, an optical disk, a semiconductor memory, a digitally encoded plastic memory, a holographic memory, or any other recording medium. Each data store 226, 230 can be stand-alone storage units as well as a storage unit formed from a plurality of physical devices, which may be remotely located from one another. Additionally, information can be stored within the data stores 226, 230 in a variety of manners. For example, information can be stored within a database structure or can be stored within one or more files of a file storage system, where each file may or may not be indexed for information searching purposes.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A compiled speech recognition grammar comprising:
a plurality of entries, each entry having a unique identifier and a phonetic representation that is used when matching speech input against the entries, each entry lacking a textual spelling corresponding to the phonetic representation, wherein said compiled speech recognition grammar is digitally encoded and stored in a computer readable media.

2. The grammar of claim 1, wherein said compiled speech recognition grammar is a context dependent grammar.

3. The grammar of claim 1, wherein said compiled speech recognition grammar is a context independent grammar.

4. The grammar of claim 1, wherein said compiled speech recognition grammar is a speaker dependent grammar.

5. The grammar of claim 1, wherein said compiled speech recognition grammar is a speaker independent grammar.

6. The grammar of claim 1, wherein each of the plurality of entries are organized in a hierarchy structure by phonetic commonalities.

7. The grammar of claim 6, wherein each terminal node of the hierarchy structure is associated with one of the unique identifiers.

8. A method for reducing a size of speech recognition grammars comprising:
omitting the textual representation for a spelling of a plurality of items in a compiled speech recognition grammar, where each grammar item comprises a unique item identifier and a phonetic representation of the entry, wherein the compiled recognition grammar is digitally encoded and stored in a computer readable media.

9. The method of claim 8, further comprising:
receiving audio input containing speech;
speech processing the audio input using the compiled speech recognition grammar;
determining at least one grammar item of the speech recognition grammar matching the audio input from the speech processing system; and
performing a programmatic action involving the at least one grammar item, which identifies the grammar item by the unique item identifier.

10. The method of claim 9, further comprising:
determining a need for a textual representation for the grammar item;
querying a data store of content items using the unique key to determine a textual spelling of the grammar item, wherein the content items of the data store comprises an entry for each of the grammar items indexed by the unique item identifier; and
executing a programmatic action involving the determined textual spelling.

11. The method of claim 10, wherein the computer readable medium is a persistent memory store of a speech enabled computing device, which is configured to respond to spoken phrases corresponding to the plurality of items, said method further comprising:
identifying a content item in the queried data store indexed by the unique item identifier, which initially lacks a corresponding entry in the compiled speech recognition;
generating speech recognition data including the phonetic representation by executing a programmatic action within the speech enabled computing device; and
adding an entry to the compiled speech recognition grammar that includes the generated phonetic representation and the unique item identifier.

12. The method of claim 10, wherein the computer readable medium is a persistent memory store of a speech enabled computing device, which is configured to respond to spoken phrases corresponding to the plurality of items, wherein said speech enabled computing device is at least one of a portable and an embedded computing device.

13. The method of claim 10, further comprising:
optimizing said plurality of entries within the compiled speech grammar in a hierarchy structure by phonetic commonalities.

14. A speech enabled computing device comprising:
a content data store comprising a plurality of content items, each content item having an associated textual description providing an item spelling and a unique identifier;
a content handler that is software stored in a medium and executable by a speech enabled computing device, which causes the device to perform at least one programmatic action involving one of the content items;
audio transducer configured to capture audio input;
a speech recognition grammar comprising a plurality of grammar entries, each grammar entry having the unique identifier and a phonetic representation that is used when matching speech input against the grammar entries, wherein each grammar entry lacks a textual spelling corresponding to the phonetic representation, wherein said speech recognition grammar is digitally encoded and stored in a computer readable media; and
a speech recognition engine configured to speech recognize audio input captured by the audio transducer in accordance with the entries of the speech recognition grammar, wherein results of the speech recognition engine are used to trigger programmatic actions of the content handler relating to the content items.

15. The speech enabled computing device of claim 14, further comprising:
a grammar compiler configured to automatically generate grammar entries for the speech recognition grammar for the content items, wherein the grammar compiler is software of the speech enabled computing device stored in a machine readable media.

16. The speech enabled computing device of claim 14, wherein said speech enabled computing device is at least one of a portable computing device and embedded computing device.

17. The speech enabled computing device of claim 14, wherein said speech enabled computing device is one of a mobile phone, personal data assistant, personal navigation device, vehicle navigation device, and a portable media player.

18. The speech enabled computing device of claim 14, wherein each of the plurality of grammar entries are organized in a hierarchy structure by phonetic commonalities.

19. The speech enabled computing device of claim 18, wherein each terminal node of the hierarchy structure is associated with one of the unique identifiers.
